(19) United States
(12) Patent Application Publication
(10) Pub. No.: US 2007/0294469 A1
(43) Pub. Date: Dec. 20, 2007

(54) Integrated circuit chip, data reading method, and data writing method

(75) Inventor: Katsuyuki Teruyama, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/806,885

(22) Filed: Jun. 5, 2007

(30) Foreign Application Priority Data
Jun. 16, 2006 (JP) 2006-167300

(51) Int. Cl. G06F 12/00

(52) U.S. Cl. 711/103

(57) ABSTRACT

An integrated circuit chip includes a memory storing a duplexed data set and capable of data rewriting. The memory is a nonvolatile memory capable of performing data rewriting in units of bytes without necessity of data deletion in units of pages.

### CROSS REFERENCES TO RELATED APPLICATIONS

The present invention contains subject matter related to Japanese Patent Application JP 2006-167300 filed in the Japanese Patent Office on Jun. 16, 2006, the entire contents of which are incorporated herein by reference.

### BACKGROUND OF THE INVENTION

1. Field of the Invention

The present invention relates to integrated circuit (IC) chips, data reading methods, and data writing methods, and more particularly, to an integrated circuit (IC) chip, a data reading method, and a data writing method for duplexing data to form a duplexed data set and holding the duplexed data set in order to deal with a case where power interruption occurs during data updating.

2. Description of the Related Art

In recent years, various services using IC cards have been developed. An IC card includes a nonvolatile memory (NVM) for holding data. In order to deal with a case where power interruption occurs during data writing, data is duplexed to form a duplexed data set and the duplexed data set is held in the NVM. A memory management method for maintaining the consistency of data even when power interruption occurs during data writing is disclosed in Japanese Unexamined Patent Application Publication No. 11-25003 “Information Processing Method and Information Processing Apparatus”.

### SUMMARY OF THE INVENTION

When an NVM of a type that performs deletion and rewriting in units of pages, such as an electrically erasable programmable read-only memory (EEPROM), which is assumed in the related art described above, is used, at the time of data update, data to be updated is transferred to a random-access memory (RAM) and then data that has been updated in the RAM is rewritten to the NVM. Thus, in the known method, complicated processing is performed for memory management to deal with power interruption during data writing.

It is desirable to provide a novel and improved integrated circuit chip, data reading method, and data writing method capable of simplifying processing for memory management to maintain the consistency of data even when power interruption occurs during data writing.

According to an embodiment of the present invention, an integrated circuit chip is provided. The integrated circuit chip includes a memory storing a duplexed data set and capable of data rewriting (reading and writing). The memory is a nonvolatile memory capable of performing data rewriting in units of bytes without necessity of data deletion in units of pages.

In the related art, when data stored in an IC card is updated, it is necessary for an NVM, such as an EEPROM, to perform deletion and rewriting in units of pages. Thus, after a certain amount of data in the NVM is copied to a RAM (volatile memory) and the data in the RAM is updated, a page of the NVM is deleted and rewriting is performed. In contrast, in an embodiment of the present invention, since an NVM capable of performing direct rewriting in units of bytes without necessity of deletion is used, copying to a RAM is not necessary. Thus, at the time of data update, simple processing can be performed in which an invalid side of a duplexed data set is updated and switching between the valid side and the invalid side is performed at the end.

In the integrated circuit chip, for example, the memory may be, for example, an FeRAM. The FeRAM is a type of nonvolatile memory using a ferroelectric. The ferroelectric is a dielectric capable of freely changing the direction of spontaneous polarization in a substance (a state in which an electrically positive or negative polarity in the substance is generated) by application of a voltage and maintaining the polarization direction even when no voltage is applied (a substance in which an electric charge is charged by polarization and a direct current does not flow through the substance). The FeRAM is a nonvolatile memory including such a ferroelectric serving as a storage element. The FeRAM has a configuration similar to a DRAM and is capable of performing reading and writing at a high speed, which is equal to or more than ten times the reading and writing speed of a flash memory. In addition, the FeRAM achieves a significantly higher reliability compared with a flash memory or an EEPROM.

In addition, the nonvolatile memory may adopt a data structure, for example, including a duplexed root table set, each root table of the duplexed root table set holding information on the correspondence between a logical block and a physical block and a counter for broken transaction and a table switch indicating which root table of the duplexed root table set is valid or invalid. Since rewriting is performed in units of bytes, it is unnecessary to perform writing for each page (segment). Thus, a segment table can be deleted from the data structure.

In addition, the integrated circuit chip may be mounted in an IC card or a data processing apparatus, such as a cellular phone or a personal digital assistant (PDA). Various services can be developed using IC cards, cellular phones, or the like that have been widely used and that may be developed in the future.

According to another embodiment of the present invention, a data reading method for reading data from an integrated circuit chip including a nonvolatile memory capable of performing rewriting in units of bytes without necessity of data deletion in units of pages and a volatile memory is provided. The nonvolatile memory includes a duplexed root table set, each root table of the duplexed root table set holding information on the correspondence between a logical block and a physical block and a counter for broken transaction, and a table switch indicating which root table of the duplexed root table set is valid or invalid. The data reading method includes the steps of starting up the integrated circuit chip, acquiring from the valid side of the duplexed root table set stored in the nonvolatile memory the position of data designated to be read and copying the acquired data to a buffer in the volatile memory, and reading the data from the volatile memory.

The step of starting up the integrated circuit chip may include the steps of checking a valid side of the duplexed root table set using the table switch and copying information on the physical block corresponding to the logical block from the valid side to the invalid side of the duplexed root table set.

The nonvolatile memory may be, for example, an FeRAM.

According to another embodiment of the present invention, a data writing method for writing data to an integrated circuit chip including a nonvolatile memory capable of performing rewriting in units of bytes without necessity of data deletion in units of pages is provided. The nonvolatile memory includes a duplexed root table set, each root table of the duplexed root table set holding information on the correspondence between a logical block and a physical block and a counter for broken transaction, and a table switch indicating which root table of the duplexed root table set is valid or invalid. The data writing method includes the steps of starting up the integrated circuit chip, acquiring from the invalid side of the duplexed root table set stored in the nonvolatile memory the position of data designated to be written and updating the invalid side of the duplexed root table set so as to indicate the position at which the new data is stored, and inverting the table switch to perform switching between the valid side and the invalid side of the duplexed root table set.

The step of starting up the integrated circuit chip may include the steps of checking a valid side of the duplexed root table set using the table switch and copying information on the physical block corresponding to the logical block from the valid side to the invalid side of the duplexed root table set.

The nonvolatile memory may be, for example, an FeRAM.

As described above, processing for memory management to maintain the consistency of data even when power interruption occurs during data writing can be simplified.

### BRIEF DESCRIPTION OF THE DRAWINGS

FIG. 1 is an explanatory diagram of a system using an IC card;

FIG. 2 is an explanatory diagram showing the flow of a broken transaction process;

FIG. 3 is an explanatory diagram of a data structure;

FIG. 4 is an explanatory diagram showing a startup process;

FIG. 5 is an explanatory diagram showing a data reading process;

FIG. 6 is an explanatory diagram showing a data writing process;

FIG. 7 is an explanatory diagram showing a data structure of a direct-update file system;

FIG. 8 is an explanatory diagram showing a startup process;

FIG. 9 is an explanatory diagram showing a data reading process; and

FIG. 10 is an explanatory diagram showing a data writing process.

### DESCRIPTION OF THE PREFERRED EMBODIMENTS

An integrated circuit (IC) chip, a data reading method, and a data writing method according to an embodiment of the present invention will be described with reference to the drawings. In the specification and drawings, elements having fundamentally the same functional configuration are referred to with the same reference numerals or symbols and redundant explanations of those elements will not be provided.

A configuration of a system using an IC card and a configuration of the IC card will first be described. Then, the flow of a broken transaction process of the IC card will be described. In addition, a data structure of tables, a startup process, a data reading process, and a data writing process in an EEPROM, which is a type of nonvolatile memory (NVM) of the IC card, will be described. Moreover, as features of this embodiment, a data structure of a table, a startup process, a data reading process, and a data writing process in a case where the NVM of the IC card is a ferroelectric random-access memory (FeRAM) will be described.

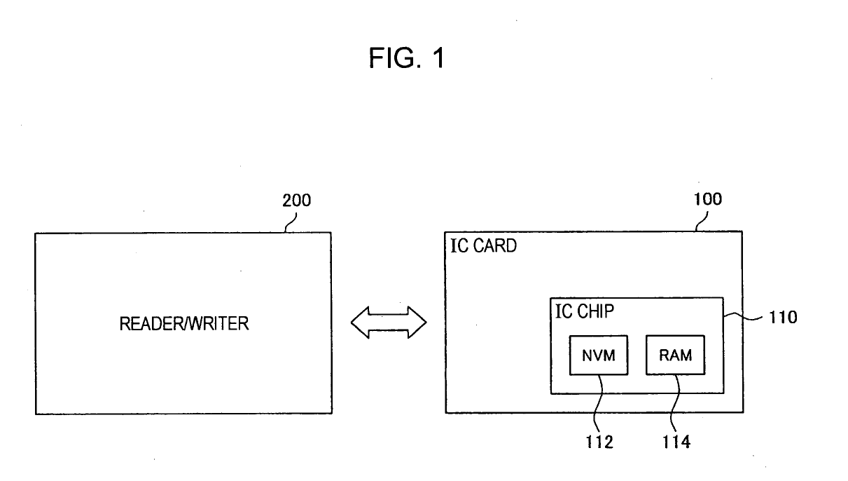

System Configuration (FIG. 1)

FIG. 1 is an explanatory diagram showing an example of a configuration of a system using an IC card. In the example shown in FIG. 1, the system includes an IC card 100 including an IC chip 110. The system also includes a reader/writer 200 that performs reading and writing of data from and to the IC card 100 via direct communication with the IC card 100.

The IC chip 110 for holding data is provided in the IC card 100. As shown in FIG. 1, the IC chip 110 includes a nonvolatile memory (NVM) 112 capable of holding stored contents even after power is turned off and a RAM (an example of a volatile memory) 114 that erases stored contents after power is turned off. The NVM 112 holds data on various services that can be used with the IC card 100. The RAM 114 is used for temporarily holding data, for example, when data reading or data writing is performed.

The IC card 100 may be a card-type data communication apparatus. Alternatively, an IC chip having an IC card function may be contained in an information communication terminal apparatus (data processing apparatus), such as a cellular phone. In this specification, for the sake of convenience, irrespective of whether the IC card is contained in an apparatus or is configured to be connectable to or disconnectable from the apparatus, the term “IC card” may be used. In addition, the IC chip having the IC card function is provided in a portable terminal, such as a cellular phone or a personal digital assistant (PDA), or in an information processing terminal, such as a personal computer (PC), and performs data communication with an external apparatus. In this case, the IC card 100 includes an interface for allowing connection with an external apparatus as well as an interface for allowing wired or wireless connection with the reader/writer 200.

The reader/writer 200 has a function of directly communicating with the IC card 100 to read data recorded in the IC card 100 and write data to the IC card 100. The data communication between the IC card 100 and the reader/writer 200 is achieved via wireless communication based on, for example, the principle of electromagnetic induction. The reader/writer 200 is integrated with an information processing apparatus, such as a computer, or performs communication via a cable or the like. Such an information processing apparatus is controlled by a service provider. Various services using IC cards are developed.

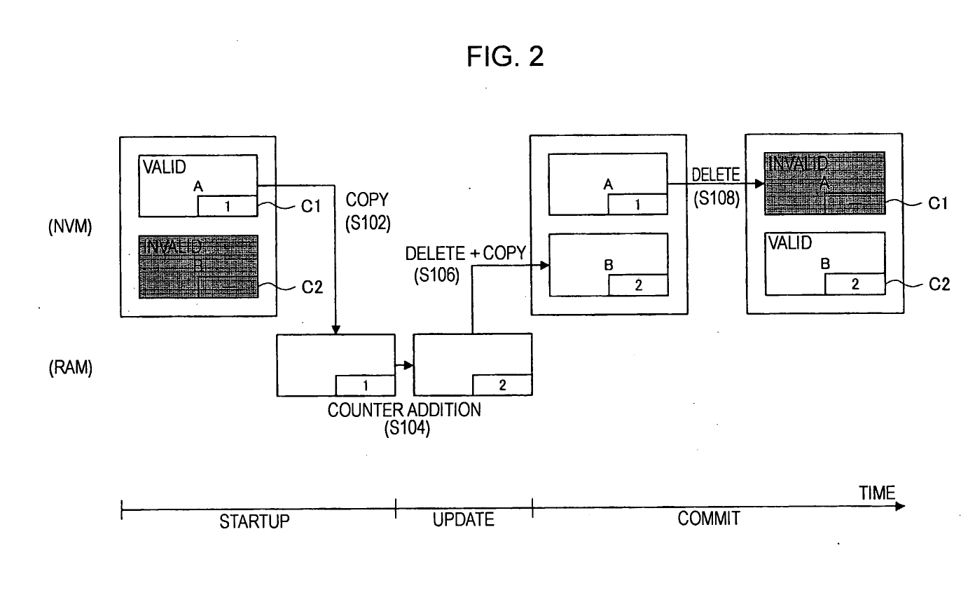

Flow of Broken Transaction Process (FIG. 2)

A broken transaction process performed in the NVM 112 and the RAM 114 of the IC chip 110 shown in FIG. 1 will be mainly described. The term “broken transaction” means power interruption during data writing to an IC card. FIG. 2 shows a general flow of the process when a file system has a simple data structure.

First, in order to deal with broken transaction, data stored in the NVM 112 is duplexed. Referring to FIG. 2, each of data A and data B represents data for a page in the NVM 112. The data A and the data B include counters C1 and C2, respectively, to indicate which of the data A or the data B is valid. At the time of startup, the counter C1 indicates “1” and the counter C2 indicates “-” Thus, the data A is valid and the data B is invalid.

At the time of startup, the data A, which is valid, in the NVM 112 is copied to the RAM 114 (step S102). At the time of update, the data in the RAM 114 is updated, and counter addition is performed (step S104). At the time of commit, the data in the RAM 114 is copied to the invalid side B in the NVM 112. When the NVM 112 is an EEPROM, since data deletion is necessary before rewriting, the data copying is performed after the invalid data B is deleted (step S106). Then, the valid data A is deleted (step S108). In this state, the counter C1 indicates “-” and the counter C2 indicates “2”. Thus, the data A is invalid and the data B is valid.

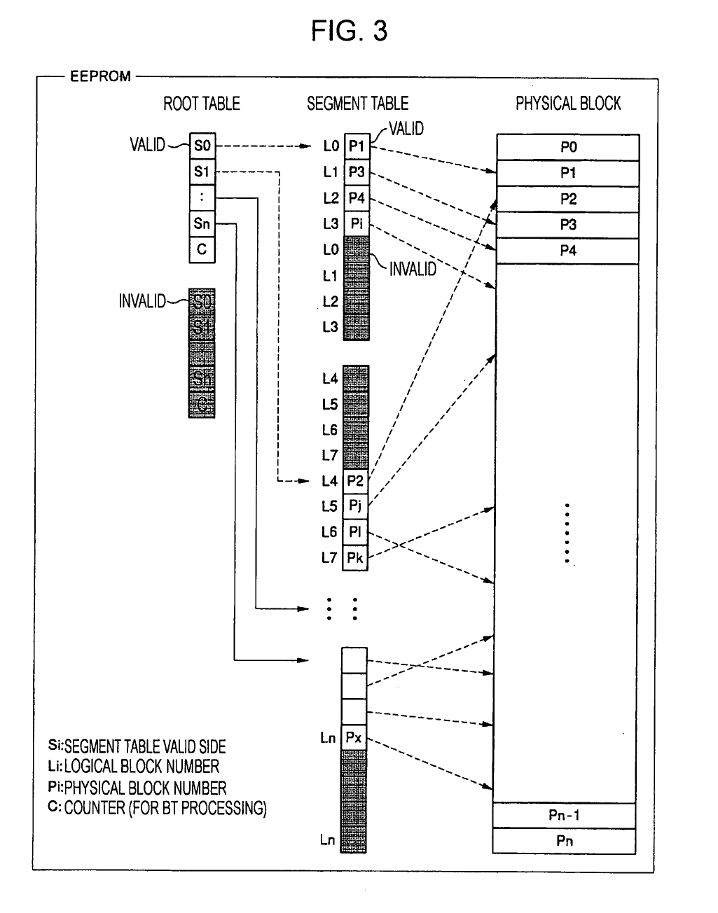

Data Structure (FIG. 3)

FIG. 3 is an explanatory diagram showing a data structure of management tables in an EEPROM in the actual file system.

The management tables of the EEPROM are a root table and a segment table, as shown in FIG. 3. The segment table includes a correspondence list of logical blocks (Li) and physical blocks (Pi). A segment table corresponds to one page of the EEPROM, and the segment table is duplexed to form a segment table set. Information indicating which table of the duplexed segment table set is valid or invalid is held in a root table, and the root table is also duplexed to form a duplexed root table set. A root table includes information on a valid side (Si) of a segment table set. In addition, similarly to the “flow of the broken transaction process” described above, a counter C for broken transaction is held in the root table.

When a correspondence list of logical blocks and physical blocks can be contained in a page, which is a unit of rewriting of the EEPROM, requirements for dealing with broken transaction can be satisfied. However, when a page has 64 bytes, only 64 user blocks can be controlled. Thus, a plurality of segment tables are prepared, and a root table controls the plurality of segment tables.

Cyclic redundancy check (CRC) is provided for the root table and the segment tables. CRC is performed when reading from the EEPROM or writing to the EEPROM is performed.

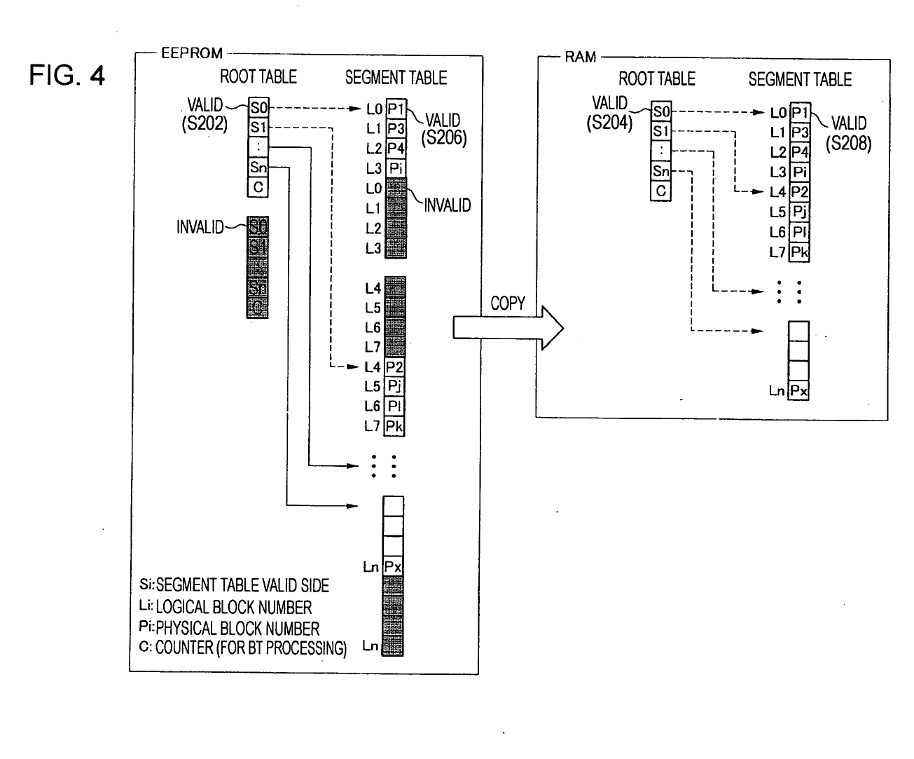

Startup Process (FIG. 4)

FIG. 4 is an explanatory diagram showing a startup process.

First, a management table valid side in the EEPROM is copied to the RAM. When it is determined that an error has occurred in accordance with a result of CRC of a root table set, in the process for dealing with broken transaction, a valid side of the root table set is determined by performing CRC and checking counters for each table of the root table set.

As shown in FIG. 4, an unerased side of the root table set is determined to be a valid side by referring to contents of each table of the root table set in the EEPROM (step S202). The root table valid side is copied from the EEPROM to the RAM (step S204). A segment table valid side is acquired in accordance with a segment bitmap (S0, S1, . . . , or Sn) in the root table in the RAM (step S206). The segment table valid side is copied from the EEPROM to the RAM (step S208). The processing of steps S202 and S204 is repeated the number of times corresponding to the number of segment tables.

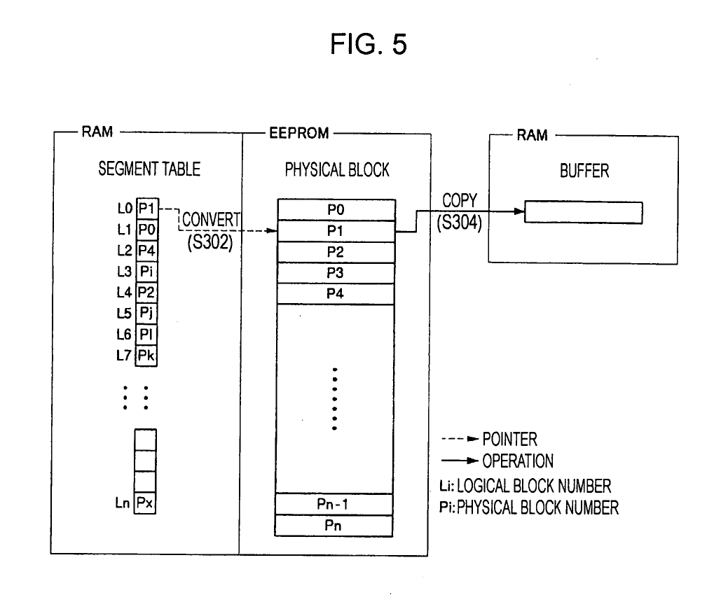

Data Reading Process (FIG. 5)

FIG. 5 is an explanatory diagram showing a data reading process.

In the data reading process, the position of designated data is acquired from a management table in the RAM, and the data is copied from a physical block (EEPROM) to a buffer (RAM).

Referring to FIG. 5, in accordance with information in a segment table in the RAM, a designated logical block number is converted into a physical block number (step S302). Then, data is copied from a physical block in the EEPROM corresponding to the physical block number to the buffer in the RAM (step S304).

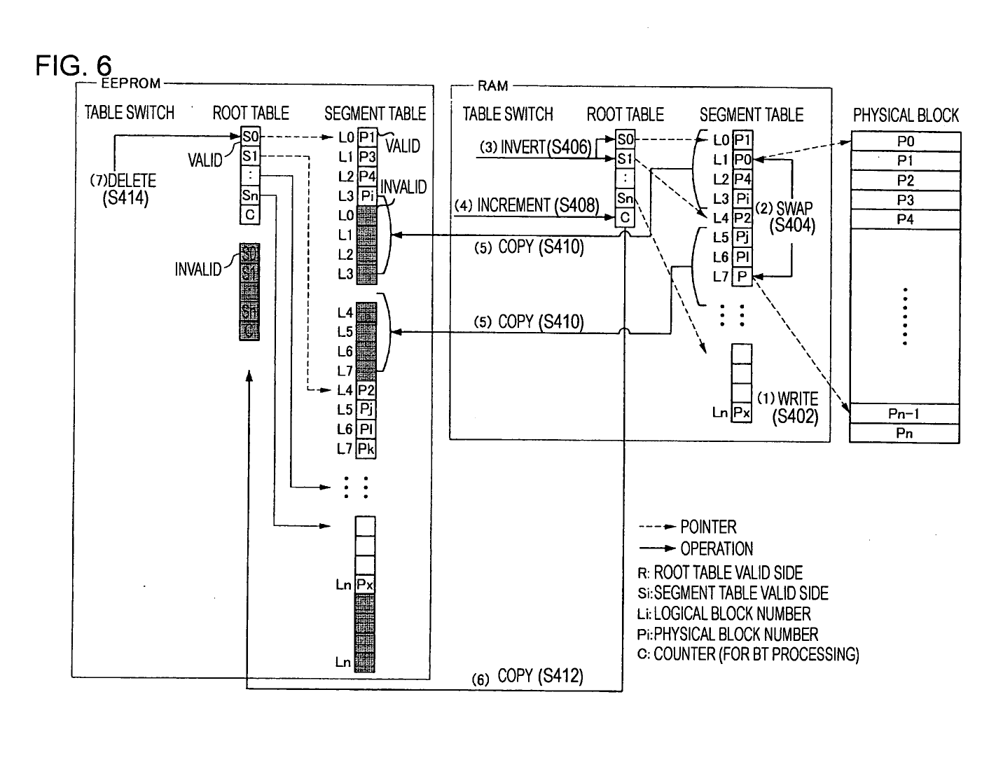

Data Writing Process (FIG. 6)

FIG. 6 is an explanatory diagram showing a data writing process.

In the data writing process, the position of designated data is acquired from a management table in the RAM, the management table in the RAM is updated such that the position at which new data is stored is indicated, and information on the update is copied to the EEPROM. The EEPROM performs deletion before copying.

Designated data is written to a writing buffer (Pn-1 in FIG. 6) in the EEPROM (step S402). In a segment table in the RAM, an element (L7) indicating the position of the writing buffer is swapped for an element (L1) indicating the position of data to be written (step S404). Segment bitmaps in a root table in the RAM corresponding to segment tables for which the swapping has been performed are inverted (step S406). Thus, switching between a valid side and an invalid side is performed.

A counter of the root table in the RAM is incremented (step S408). The segment table is copied from the RAM to segment table invalid sides of the EEPROM (step S410). Then, the root table is copied from the RAM to the root table invalid side of the EEPROM (step S412). Finally, the root table valid side is deleted.

Although the process to update two segment table elements has been described, when a plurality of pieces of data is written, processing of writing to a writing buffer and updating a segment table (steps S402 to S406) is repeatedly performed. Since the final writing to the EEPROM is achieved by performing rewriting and deletion of a root table, a plurality of pieces of data can be updated at the same time. In addition, since writing to the EEPROM is performed at the end of the writing process, the number of writing times can be reduced compared with a case where the EEPROM is sequentially updated.

<File System when FeRAM is Used>

A file system when an FeRAM is used, which is a feature of this embodiment, will be described. The FeRAM is a type of nonvolatile memory using a ferroelectric. The ferroelectric is a dielectric capable of freely changing the direction of spontaneous polarization in a substance (a state in which an electrically positive or negative polarity in the substance is generated) by application of a voltage and maintaining the polarization direction even when no voltage is applied (a substance in which an electric charge is charged by polarization and a direct current does not flow through the substance). The FeRAM is a nonvolatile memory including such a ferroelectric serving as a storage element. The FeRAM has a configuration similar to a DRAM and is capable of performing reading and writing at a high speed, which is equal to or more than ten times the reading and writing speed of a flash memory. In addition, the FeRAM achieves a significantly higher reliability compared with a flash memory or an EEPROM.

When an FeRAM is used as a storage memory, it is necessary to design a file system taking into consideration the restriction on a memory device of the FeRAM, similarly to a case where an EEPROM is used. That is, for data rewriting, it is necessary for an EEPROM to perform deletion and writing in units of pages. However, an FeRAM is capable of performing rewriting in units of bytes without necessity of deletion. In addition, compared with an EEPROM, data can be rewritable a larger number of times and a shorter rewrite processing time is necessary in an FeRAM. When a file system using such a nonvolatile memory that is capable of performing rewriting in units of bytes is designed, the points described below are considered.

(a) Since writing in units of bytes is possible and only a short write time is necessary, data updating in an NVM can be performed in a distributed manner in a write process, instead of being performed collectively at the end of the write process. Thus, the time necessary for the write process may be reduced.

(b) Since writing in units of bytes is possible, it is not necessary to control data in units of pages (segments). Thus, a simplification of a data structure and a reduction in the processing time may be achieved.

(c) Since writing in units of bytes is possible and the number of rewritable times is equal to or more than 108, data in an FeRAM may be directly updated without being transferred to a RAM. Thus, the amount of use of the RAM can be reduced.

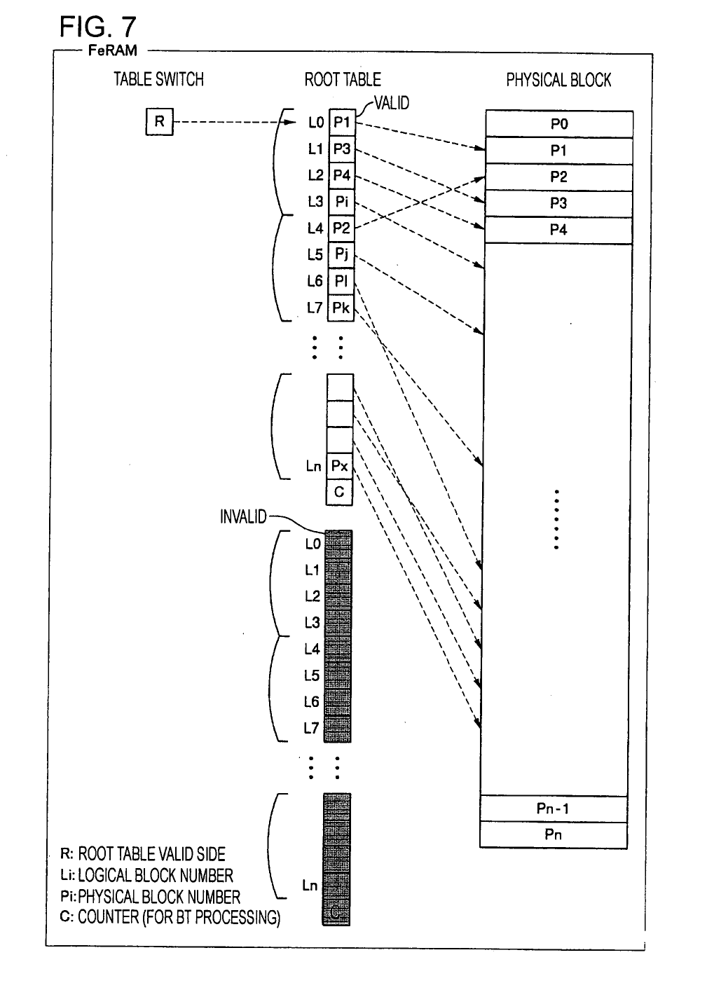

Data Structure (FIG. 7)

FIG. 7 shows a data structure of a direct-update file system using an FeRAM.

A management table of the FeRAM includes only a root table, as shown in FIG. 7. A root table includes a correspondence list of logical blocks (Li) and physical blocks (Pi) and a counter C for broken transaction. The root table is duplexed to form a duplexed root table set. The FeRAM also includes a table switch (R) indicating which table of the root table set is valid or invalid.

In the case of FeRAM, since writing is performed in units of bytes, it is not necessary to perform writing for each page (segment). Thus, segment tables can be deleted from the data structure. Since no segment table is used, it is not necessary to perform rewriting of a non-updated portion of a segment table with the same data. Thus, the number of writing times of the memory is reduced. In addition, since it is not necessary to control a plurality of segment tables, related processing can be eliminated.

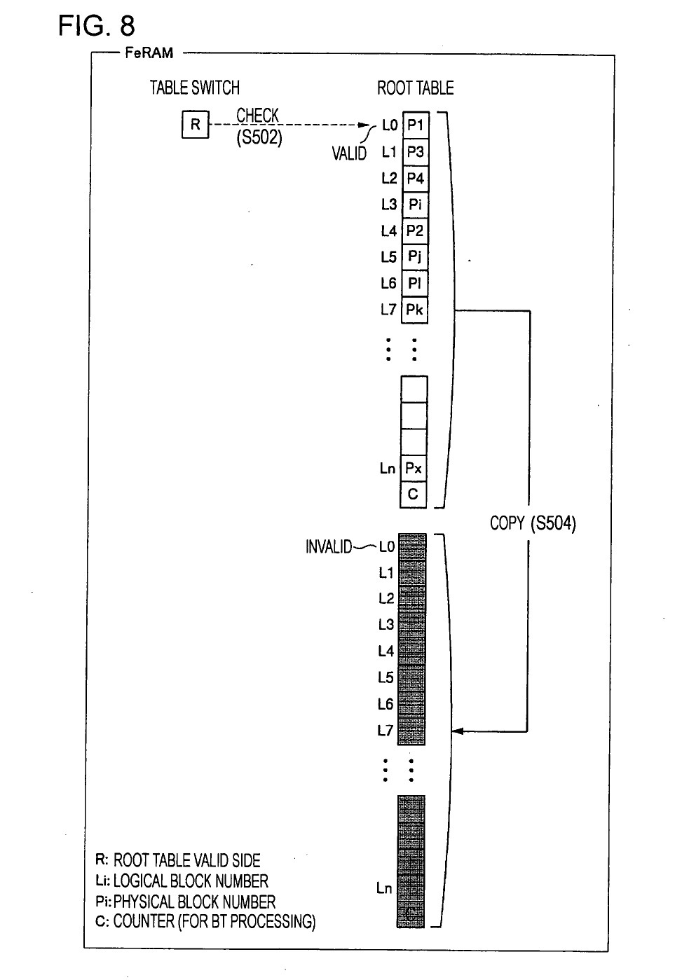

Startup Process (FIG. 8)

FIG. 8 is an explanatory diagram showing a startup process.

In the startup process, a management table valid side in the FeRAM is copied to a management table invalid side in the FeRAM. Since only the valid side is accessed in a data reading process, the copying of the management table valid side may be performed immediately before the data writing process.

As shown in FIG. 8, a root table valid side in the FeRAM is checked in accordance with the table switch (step S502). Then, the root table valid side (FeRAM) is copied to the root table invalid side (FeRAM) (step S504).

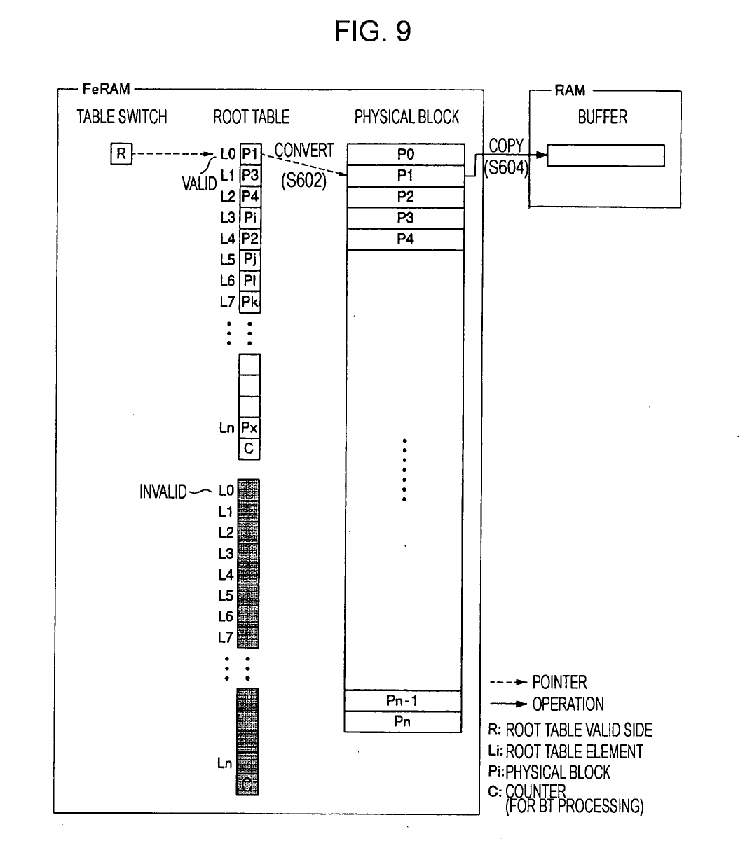

Data Reading Process (FIG. 9)

In the data reading process, the position of designated data is acquired from the root table valid side in the FeRAM, and the data is copied from a physical block (FeRAM) to a buffer (RAM).

As shown in FIG. 9, a designated logical block number is converted into a physical block number in accordance with information in the root table valid side, as shown in FIG. 9 (step S602). Then, data is copied from a physical block in the FeRAM corresponding to the physical block number to a buffer in the RAM (step S604).

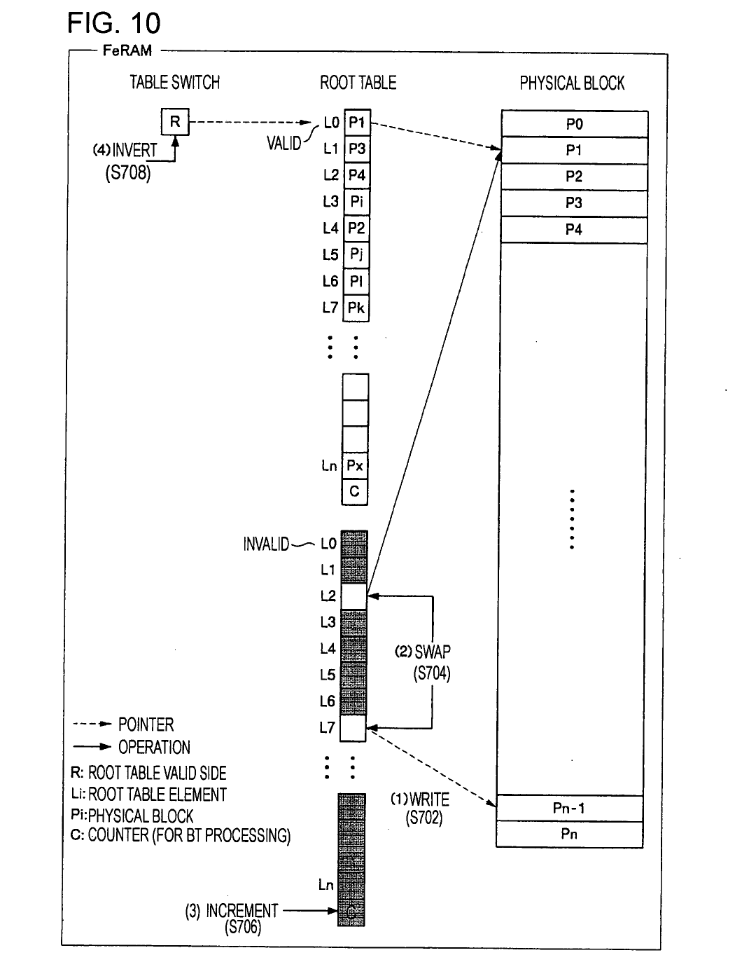

Data Writing Process (FIG. 10)

In the data writing process, the position of designated data is acquired from the root table invalid side in the FeRAM, and the root table invalid side in the FeRAM is updated so as to indicate the position at which new data is stored. Finally, the table switch in the FeRAM is updated.

As shown in FIG. 10, the designated data is written to a writing buffer (Pn-1 in FIG. 10) in the FeRAM (step S702), as shown in FIG. 10. Then, in the root table invalid side in the FeRAM, an element (L7) indicating the position of the writing buffer is swapped for an element (L2) indicating the position of data to be written (step S704). The counter in the root table invalid side in the FeRAM is incremented (step S706). Finally, the table switch is inverted (step S708). Thus, switching between the valid side and the invalid side is achieved.

Since the final writing to the FeRAM is performed using the table switch, a plurality of pieces of data can be updated at the same time. When a plurality of pieces of data are updated, processing in the writing buffer and the root table invalid side (steps S702 to S706) is repeatedly performed.

As described above, according to the foregoing embodiment, since direct rewriting can be performed in units of bytes, it is not necessary to perform control in units of pages, thus achieving a simplified data structure. In addition, since data in an FeRAM is directly rewritable, at the time of update, instead copying to a RAM, copying to an invalid side of the FeRAM, which has been subjected to duplexing, is performed. Thus, the amount of use of the RAM can be reduced. Furthermore, since a simplified data structure is achieved and copying from the RAM to the FeRAM at the time of data update is unnecessary, the time necessary for the data writing process can be reduced.

Although an IC chip, a data reading method, and a data writing method according to the foregoing embodiment has been described with reference to the drawings, the present invention is not limited to the foregoing embodiment. It is obvious that various changes and modifications made within the technical scope described in the claims can be conceived by those skilled in the art. Thus, it should be understood that various changes and modification made without departing from the technical scope described in the claims fall within the technical scope of the present invention.

For example, although a case where an FeRAM, which is as an example of a nonvolatile memory capable of performing rewriting in units of bytes without necessity of data deletion in units of pages, is used has been described in the foregoing embodiment, the present invention is not limited to the case where an FeRAM is used. Any type of nonvolatile memory (including nonvolatile memories that may be developed in the future) capable of performing rewriting in units of bytes without necessity of data deletion in units of pages can be used.

It should be understood by those skilled in the art that various modifications, combinations, sub-combinations and alterations may occur depending on design requirements and other factors insofar as they are within the scope of the appended claims or the equivalents thereof.

What is claimed is:

1. An integrated circuit chip comprising:
a memory storing a duplexed data set and capable of data rewriting,
wherein the memory is a nonvolatile memory capable of performing data rewriting in units of bytes without necessity of data deletion in units of pages.

2. The integrated circuit chip according to claim 1, wherein the nonvolatile memory is a ferroelectric random access memory.

3. The integrated circuit chip according to claim 1, wherein the nonvolatile memory has a data structure including:
a duplexed root table set, each root table of the duplexed root table set holding information on the correspondence between a logical block and a physical block and a counter for broken transaction; and
a table switch indicating which root table of the duplexed root table set is valid or invalid.

4. A data reading method for reading data from an integrated circuit chip including a nonvolatile memory capable of performing rewriting in units of bytes without necessity of data deletion in units of pages and a volatile memory, the nonvolatile memory including a duplexed root table set, each root table of the duplexed root table set holding information on the correspondence between a logical block and a physical block and a counter for broken transaction, and a table switch indicating which root table of the duplexed root table set is valid or invalid, comprising the steps of:
starting up the integrated circuit chip;
acquiring from the valid side of the duplexed root table set stored in the nonvolatile memory the position of data designated to be read and copying the acquired data to a buffer in the volatile memory; and
reading the data from the volatile memory.

5. The data reading method according to claim 4, wherein the step of starting up the integrated circuit chip includes the steps of:
checking a valid side of the duplexed root table set using the table switch; and
copying information on the physical block corresponding to the logical block from the valid side to the invalid side of the duplexed root table set.

6. The data reading method according to claim 4, wherein the nonvolatile memory is a ferroelectric random access memory.

7. A data writing method for writing data to an integrated circuit chip including a nonvolatile memory capable of performing rewriting in units of bytes without necessity of data deletion in units of pages, the nonvolatile memory including a duplexed root table set, each root table of the duplexed root table set holding information on the correspondence between a logical block and a physical block and a counter for broken transaction, and a table switch indicating which root table of the duplexed root table set is valid or invalid, comprising the steps of:
starting up the integrated circuit chip;
acquiring from the invalid side of the duplexed root table set stored in the nonvolatile memory the position of data designated to be written and updating the invalid side of the duplexed root table set so as to indicate the position at which the new data is stored; and
inverting the table switch to perform switching between the valid side and the invalid side of the duplexed root table set.

8. The data writing method according to claim 7, wherein the step of starting up the integrated circuit chip includes the steps of:
checking a valid side of the duplexed root table set using the table switch; and
copying information on the physical block corresponding to the logical block from the valid side to the invalid side of the duplexed root table set.

9. The data writing method according to claim 7, wherein the nonvolatile memory is a ferroelectric random access memory.
